(19) United States
(12) Patent Application Publication
(10) Pub. No.: US 2017/0015201 A1
(43) Pub. Date: Jan. 19, 2017

(54) SYSTEM AND METHOD FOR MONITORING OPERATION OF RETARDING GRID ASSOCIATED WITH TRACTION MOTOR OF MACHINE

(71) Applicant: Caterpillar Inc., Peoria, IL (US)

(72) Inventors: Alexander C Crosman, III, Dunlap, IL (US); Baoyong Liu, Dunlap, IL (US); Joshua M Williams, Peoria, IL (US); Brett M Nee, Germantown Hills, IL (US)

(73) Assignee: Caterpillar Inc., Peoria, IL (US)

(21) Appl. No.: 14/799,659

(22) Filed: Jul. 15, 2015

(51) Int. Cl. B60L 3/12; G01L 5/00; B60L 15/20; G01N 9/00

(52) U.S. Cl. CPC B60L 3/12; G01N 9/00; G01L 5/00; B60L 15/20

(57) ABSTRACT

A system for monitoring operation of a retarding grid associated with a traction motor of a machine includes a pressure sensor and a temperature sensor for measuring atmospheric pressure and temperature in real time. The system further includes a controller that determines a current air density on the basis of the measured atmospheric pressure and temperature. The controller then determines a threshold retarding power limit for the retarding grid on the basis of the current air density; and a threshold torque limit for the traction motor on the basis of the determined threshold retarding power limit and a current wheel speed of the machine. The controller determines a current retarding torque at the traction motor, and selectively generates a warning signal to an operator of the machine on the basis of the threshold torque limit determined for the traction motor and the current retarding torque at the traction motor.

### TECHNICAL FIELD

The present disclosure relates to a system for monitoring operation of a retarding grid associated with a traction motor of a machine. More particularly, the present disclosure relates to a system for generating a warning signal based on a performance of the retarding grid in a given environmental condition.

### BACKGROUND

Earth moving machines have long been known to employ retarding grids for their traction motors. These retarding grids typically contain several sets or banks of resistors that are configured for regulating an amount of power supplied to the traction motors. However, these resistors also have a propensity for heating up during operation i.e., when regulating the power or voltage to be supplied to the traction motors. Although the resistors may be cooled down by drafts of atmospheric air, for e.g., as the machine moves in a worksite or by directing air from a high-speed blower fan, fluctuations in air density can nevertheless still impact an amount of cooling to the resistors.

U.S. Pat. No. 6,847,187 (hereinafter referred to as “the '187 patent”) discloses a thermal protection apparatus for AC traction motors. The apparatus includes a stator, a rotor, a blower fan, and an inverter. The apparatus is configured to predict the motor temperature assuming that the blower is operational. The apparatus further determines an estimated motor temperature by measuring the motor resistance or the rotor slip. The apparatus then compares the estimated motor temperatures with the predicted motor temperature to determine the condition of the motor cooling system.

However, the '187 patent does not account for changes in air density and its impact on resistors of the retarding grid.

### SUMMARY OF THE DISCLOSURE

In one aspect of the present disclosure, a system for monitoring operation of a retarding grid associated with a traction motor of a machine includes a pressure sensor, a temperature sensor, and a controller. The pressure sensor and the temperature sensor are configured to measure atmospheric pressure and atmospheric temperature respectively. The controller is communicably coupled to each of the traction motor, the pressure sensor, and the temperature sensor. The controller is configured to receive the atmospheric pressure and the atmospheric temperature from the pressure sensor and the temperature sensor respectively.

The controller determines a current air density on the basis of the received atmospheric pressure and temperature. The controller then determines a threshold retarding power limit for the retarding grid on the basis of the current air density. The controller further determines a threshold torque limit for the traction motor on the basis of the determined threshold retarding power limit and a current wheel speed of the machine. The controller also determines a current retarding torque at the traction motor, and selectively generates a warning signal to an operator of the machine on the basis of the threshold torque limit determined for the traction motor and the current retarding torque at the traction motor.

In another aspect of the present disclosure, a method for monitoring operation of the retarding grid includes measuring atmospheric pressure and atmospheric temperature. The method further includes receiving, by a controller, the measured atmospheric pressure and atmospheric temperature from the pressure sensor and the temperature sensor respectively. The method further includes determining a current air density on the basis of the received atmospheric pressure and temperature. The method further includes determining a threshold retarding power limit for the retarding grid on the basis of the current air density. The method further includes determining a threshold torque limit for the traction motor on the basis of the determined threshold retarding power limit and a current wheel speed of the machine. The method further includes determining a current retarding torque at the traction motor; and selectively generating a warning signal to an operator of the machine on the basis of the threshold torque limit determined for the traction motor and the current retarding torque at the traction motor.

Other features and aspects of this disclosure will be apparent from the following description and the accompanying drawings.

### BRIEF DESCRIPTION OF THE DRAWINGS

FIG. 1 is a diagrammatic illustration of an exemplary machine, in which embodiments of the present disclosure can be implemented;

FIG. 2 is a schematic of an exemplary electric drive system and a system for monitoring operation of a retarding grid associated with a traction motor of the exemplary machine in accordance with embodiments of the present disclosure;

FIG. 3 is a flowchart illustrating a process for monitoring operation of the retarding grid, in accordance with an embodiment of the present disclosure;

FIG. 4 is a portion of a flowchart showing a low level implementation of the process for monitoring operation of the retarding grid, in an exemplary implementation of the present disclosure; and

FIG. 5 is a continuation of the flowchart from FIG. 4 showing the low level implementation of the process for monitoring operation of the retarding grid.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

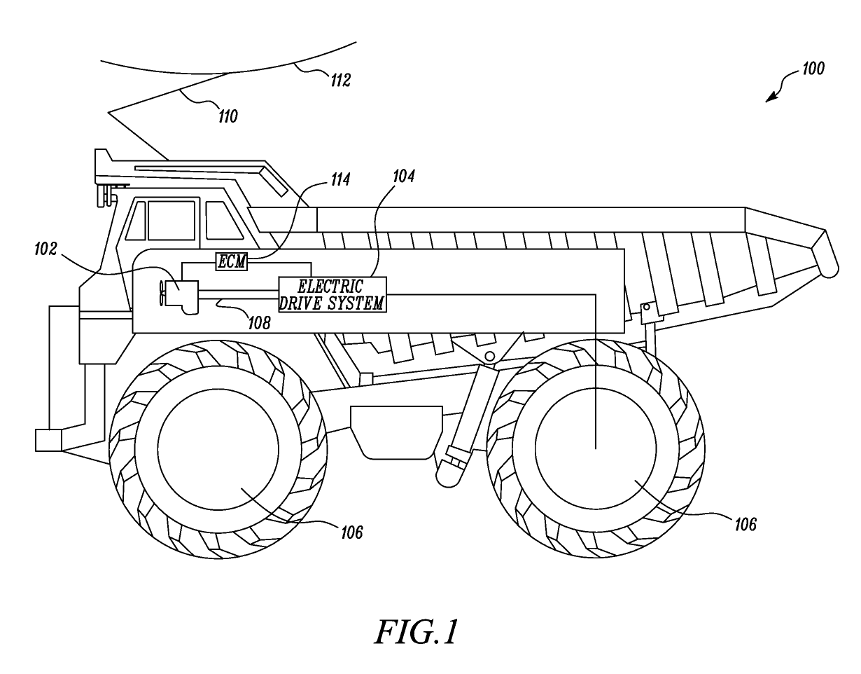

FIG. 1 illustrates an exemplary machine 100 that is embodied in the form of a wheeled vehicle, for e.g., a mining truck (as shown). The machine 100 may be used in a variety of applications including mining, quarrying, road construction, construction site preparation, etc. For example, the mining truck of the present disclosure may be employed for hauling earth materials such as soil, debris, or other naturally occurring deposits from a worksite. Although a mining truck is depicted in FIG. 1, other types of mobile machines such as, but not limited to, large wheel loaders, off-highway trucks, articulated trucks, on-highway trucks, or the like may be employed in lieu of the mining truck.

In alternative embodiments of the present disclosure, the machine 100 can optionally be embodied in the form of a tracked vehicle. Further, the machine 100 may be a manually-operated machine, an autonomous machine, or a machine that is operable in both manual and autonomous mode. Therefore, notwithstanding any particular type or configuration of machine disclosed in this document, it will be appreciated by one skilled in the art that systems and methods disclosed herein can be similarly applied to other types of machines known in the art without deviating from the spirit of the present disclosure.

Referring to FIG. 1, the machine 100 includes an engine 102, an electric drive system 104, and multiple ground engaging members for e.g., wheels 106. The engine 102 can power the machine 100 by combustion of natural resources, such as gasoline, liquid natural gas, or other petroleum products. As such, the engine 102 can be embodied as a petrol engine 102, a diesel engine 102, a dual-fuel engine 102 or any other kind of engine 102 utilizing combustion of fuel for generation of power.

The electric drive system 104, disclosed herein, may include for e.g., a series electric drive system, a parallel electric drive system, a series or parallel hybrid electric drive system, or any other type of system that uses electric power for propulsion. As shown in the embodiment of FIG. 1, the electric drive system 104 may be coupled to the engine 102 via a shaft 108 for converting mechanical torque output from the engine 102 into electric power for powering one or more wheels 106 of the machine 100.

However, in an alternative embodiment, the electric drive system 104 may, additionally or optionally, be powered with the help of a pantograph 110 and an overhead catenary 112 (shown in FIG. 1) that is provided for supplying current to the electric drive system 104. Further, as shown in the illustrated embodiment of FIG. 1, the machine 100 may also include an Electronic Control module (ECM) 114 that is configured to regulate power supplied from the engine 102 and/or the overhead catenary 112 to various components of the electric drive system 104.

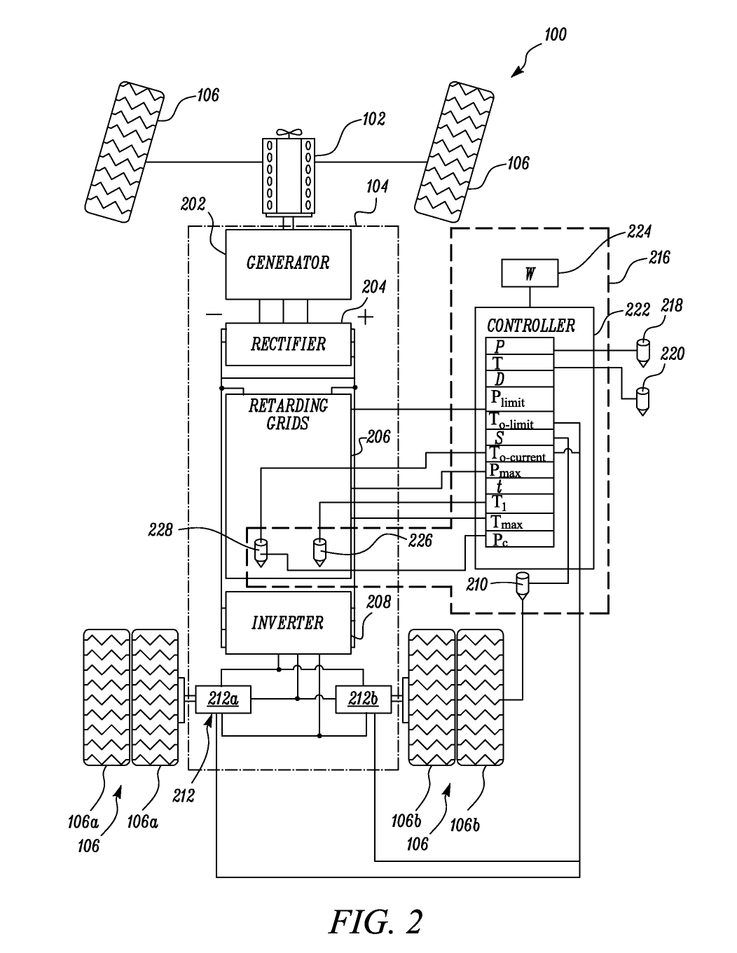

FIG. 2 provides a schematic diagram of the machine 100 and the electric drive system 104. The electric drive system 104 includes a plurality of mechanical and electrical components that co-operate to propel machine 100. As shown in the illustrated embodiment of FIG. 2, the electric drive system 104 includes components such as include a generator 202, a rectifier 204, one or more retarding or resistive grids 206, an inverter 208, and one or more electric drive motors 212 (hereinafter referred to as ‘traction motors’ or ‘traction motor/s’ and designated with similar reference numerals ‘212a, 212b’).

Generator 202, disclosed herein, may embody an electric power generator suitable for converting mechanical torque into electric power. More particularly, a rotor (not shown) of generator 202 may be coupled to the shaft 108 associated with engine 102. Upon rotation of the shaft 108 by the engine 102, the shaft 108 may rotate the rotor relative to a stator (not shown) of the generator 202, thereby generating a current in the stator coils. According to one exemplary embodiment, the generator 202 may be a three-phase AC generator.

Rectifier 204, disclosed herein, may be electrically coupled to the generator 202 and configured to convert the AC power produced by the generator 202 into DC power. Any type of rectifier may be used. According to one embodiment, the rectifier 204 may be a three-phase bridge full-wave rectifier that includes a plurality of power diodes (not shown) that are arranged in diode pairs around each phase of the output of the generator 202. Each diode pair includes two power diodes that may be connected in series to each other, with a connection to each phased output of the generator 202 between each pair. The three pairs of power diodes are connected in parallel to each other and produce DC power at the output.

Inverter 208 may be connected in parallel with the rectifier 204 and configured to transform the DC power into variable frequency sinusoidal or non-sinusoidal AC power that drives each of the traction motors 212a, 212b. The inverter 208 of the present disclosure may embody any suitable type of inverter circuit. For example, the inverter 208 may include three phase arrays of insulated gate bipolar transistors (IGBT) that are arranged in transistor pairs and that are configured to supply a 3-phase AC output to each of the traction motors 212a, 212b. In this manner, the inverter 208 can control a rotational speed of the motors 212a, 212b by controlling the frequency and/or the pulse width of the AC power output.

The traction motors 212a, 212b may include any type of motor suitable to convert electric power to mechanical torque. According to the exemplary embodiment described above, traction motors 212a, 212b may be three-phase AC motors configured to receive three-phase AC power from the inverter 208 and provide a torque output based on the frequency of the received AC power. According to one embodiment, a first traction motor i.e., 212a may be coupled to a first wheel for e.g., wheel 106b i.e. at the left side and a second traction motor 212b may be coupled to a second wheel for e.g., wheel 106b i.e. at the right side.

As shown, the wheels 106a, 106b are mechanically coupled to the traction motors 212a, 212b and hence, configured to rotate in response to a rotation of an output shaft 214 of the respective traction motor 212a, 212b. For example, in the exemplary embodiment illustrated in FIG. 2, rear wheels 106a, 106b may be coupled to traction motors 212a, 212b. This coupling may be direct (e.g., via the shafts 214) or may be indirect (e.g., via a final drive system (not shown) that operates to reduce the rate of rotation and increase the torque between the traction motors 212a, 212b and the rear wheels 106a, 106b).

Although some components pertaining to the electric drive system 104 have been disclosed herein, it is hereby contemplated that electric drive system 104 could, additionally or optionally, include other components than those illustrated in FIG. 2. For example, the electric drive system 104 may include high-speed blower fans (not shown) that are configured to direct airflow to the retarding grids 206 for dissipating any excess heat generated by the retarding grids 206 during operation.

Alternatively, the retarding grids 206 can also be configured to dissipate heat generated by the traction motors 212a, 212b when the electric drive system 104 is operating for e.g., in a retarding mode. Retarding mode, disclosed herein, may occur when the machine 100 is to be decelerated or its motion is otherwise to be retarded, for example, to prevent acceleration of the machine 100 when travelling down an incline. As known to one skilled in the art, traction motors 212a, 212b can behave like generators when kinetic energy is applied at the output shafts 214 of the traction motors 212a, 212b. For example, when the machine 100 is traveling down a steep incline, the force of gravity can cause the wheels 106a, 106b to drive the traction motors 212a, 212b in a manner similar to driving a generator, thereby supplying power back into the electric drive system 104. In order to effectively dissipate this power, some or all of the power can be supplied into the retarding grids 206. However, as the retarding grids 206 typically include numerous resistive elements (not shown) therein, the resistive elements tend to convert this excess electrical energy into heat thereby causing the retarding grids 206 to heat up during operation.

The present disclosure relates to a system 216 for monitoring an operation of the retarding grids 206. With continued reference to FIG. 2, the system 216 includes a pressure sensor 218, a temperature sensor 220, and a controller 222. The pressure sensor 218 and the temperature sensor 220 are configured to measure atmospheric pressure P and atmospheric temperature T respectively. The controller 222 is communicably coupled to each of the traction motors 212a, 212b; the pressure sensor 218; the temperature sensor 220; and the retarding grids 206. The controller 222 can therefore receive the atmospheric pressure P and the atmospheric temperature T from the pressure sensor 218 and the temperature sensor 220 respectively.

The controller 222 then determines air density D on the basis of the received atmospheric pressure P and atmospheric temperature T. In an embodiment, the pressure sensor 218 and the temperature sensor 220 can be beneficially configured to measure the atmospheric pressure P and the atmospheric temperature T in real-time. In the preceding embodiment, it may be noted that the air density D measured using such real-time values of atmospheric pressure P and atmospheric temperature T can be regarded as being representative of current air density. For the sake of convenience and simplicity in this document, the air density D measured using real-time values of atmospheric pressure P and atmospheric temperature T may hereinafter be referred to as “the current air density” and designated with identical reference alphabet “D”.

In various embodiments of this disclosure, this real-time may lie in a range of few milliseconds (ms) to a few seconds (s). For example, in one application, the real-time can be 5 ms. In another example, the real-time can be set to 10 ms. In yet another example, the real-time at which the pressure sensor 218 and the temperature sensor 220 are configured to measure the atmospheric pressure P and the atmospheric temperature T can be set to 10 seconds. Therefore, notwithstanding anything contained in this document, the real-time disclosed herein can set at a value that is configured to suit specific requirements of an application and hence, may be varied from one application to another.

The controller 222 then determines a threshold retarding power limit Pₗᵢₘᵢₜ for the retarding grid 206 on the basis of the current air density D. The controller 222 further determines a threshold torque limit Tₒ₋ₗᵢₘᵢₜ for the traction motor/s 212a, 212b on the basis of the determined threshold retarding power limit Pₗᵢₘᵢₜ and a current wheel speed S of the machine 100. As such, the system 216 can further include a wheel speed sensor 210, as shown in FIG. 2, coupled to the wheel 106 for measuring the current wheel speed S of the machine 100. The controller 222 also determines a current retarding torque T_{o-current} at the traction motor/s 212a, 212b; and selectively generates a warning signal W to an operator of the machine 100 on the basis of the threshold torque limit Tₒ₋ₗᵢₘᵢₜ determined for the traction motor/s 212a, 212b and the current retarding torque T_{o-current} at the traction motor/s 212a, 212b.

In an embodiment as illustrated in FIG. 2, the system 216 further includes an interface 224 communicably coupled to the controller 222. The interface 224 is provided for rendering the warning signal W in a suitable or interpretable form to the operator of the machine 100. The interface 224 could be of any type known to one skilled in the art. As such, the interface 224 of the present disclosure can provide warning signals in forms such as an audio signal, a visual signal, and/or a haptic feedback. However, it may be noted that a type and configuration of the interface 224 and consequently, a type of warning signal W rendered using the interface 224 is merely exemplary in nature and hence, non-limiting of this disclosure. One skilled in the art can contemplate providing the warning signal W in any suitable or interpretable form to the operator of the machine 100 without deviating from the spirit of the present disclosure.

As disclosed earlier herein, the controller 222 is configured to selectively generate the warning signal W on the basis of the threshold torque limit Tₒ₋ₗᵢₘᵢₜ determined for the traction motor/s 212a, 212b and the current retarding torque T_{o-current} at the traction motor/s 212a, 212b. In one embodiment, the controller 222 may be configured to generate the warning signal W at the interface 224 if the current retarding torque T_{o-current} at the traction motor/s 212a, 212b approaches the threshold torque limit Tₒ₋ₗᵢₘᵢₜ determined for the traction motor/s 212a, 212b. For example, the controller 222 may be configured to generate the warning signal W when the current retarding torque T_{o-current} at the traction motor/s 212a, 212b is 0.9 times that of the threshold torque limit Tₒ₋ₗᵢₘᵢₜ determined for the traction motor/s 212a, 212b. In another example, the controller 222 may be configured to generate the warning signal W when the current retarding torque T_{o-current} at the traction motor/s 212a, 212b is 0.8 times that of the threshold torque limit Tₒ₋ₗᵢₘᵢₜ determined for the traction motor/s 212a, 212b. However, in various embodiments of the present disclosure, the controller 222 could be beneficially configured to generate the warning signal W at the interface 224 when the current retarding torque T_{o-current} at the traction motor/s 212a, 212b reaches any value that is between 0.7 and 0.99 times the threshold torque limit Tₒ₋ₗᵢₘᵢₜ determined for the traction motor/s 212a, 212b.

In another embodiment of this disclosure, the controller 222 may be configured to generate the warning signal W at the interface 224 if the current retarding torque T_{o-current} at the traction motor/s 212a, 212b exceeds the threshold torque limit Tₒ₋ₗᵢₘᵢₜ determined for the traction motor/s 212a, 212b. Additionally or optionally, the controller 222 can be further configured to reduce a maximum retarding power Pₘₐₓ available from the retarding grid 206 to the traction motor/s 212a, 212b if the current retarding torque T_{o-current} at the traction motor/s 212a, 212b exceeds the threshold torque limit Tₒ₋ₗᵢₘᵢₜ determined for the traction motor/s 212a, 212b. In an example, if the threshold torque limit Tₒ₋ₗᵢₘᵢₜ determined for the traction motor/s 212a, 212b is 4000 N-m, and the current retarding torque T_{o-current} at the traction motor/s 212a, 212b is 4100 N-m, then the controller 222 generates the warning signal W and may, additionally or optionally, reduce the maximum retarding power Pₘₐₓ available in the retarding grid 206. For example, the controller 222 may reduce the maximum retarding power Pₘₐₓ from 4.5 megawatt (MW) to 4.0 MW.

However, in an alternative embodiment, the controller 222 may allow the maximum retarding power Pₘₐₓ from the retarding grid 206 to be available to the traction motor/s 212a, 212b for a pre-determined period of time t even after the current retarding torque T_{o-current} at the traction motor/s 212a, 212b exceeds the threshold torque limit Tₒ₋ₗᵢₘᵢₜ determined for the traction motor/s 212a, 212b. This pre-determined period of time t for which the maximum retarding power Pₘₐₓ continues to be available from the retarding grid 206 to the traction motor/s 212a, 212b corresponds to a time taken by a current temperature T_{current} of the retarding grid 206 to exceed a maximum allowable operating temperature Tₘₐₓ pre-defined for the retarding grid 206. For example, if the maximum allowable temperature Tₘₐₓ for the retarding grid 206 is 500 degree centigrade (C), and the retarding grid 206 is operating at a state i.e., temperature T_{current} that is beyond the cooling capabilities i.e., the maximum allowable temperature Tₘₐₓ of the retarding grid 206, then the controller 222 may allow the retarding grid 206 to continue supplying power to the traction motor/s 212a, 212b. However, this supply of power may be allowed by the controller 222 until the current operating temperature T_{current} of the retarding grid 206 exceeds the maximum allowable temperature Tₘₐₓ of 500° C. for the retarding grid 206.

In one embodiment as shown in FIG. 2, the system 216 can further include a temperature sensor 226 that is configured for measuring the current temperature T_{current} of the retarding grid 206. However, in an alternative embodiment, the controller 222 can also estimate the current temperature T_{current} of the retarding grid 206 on the basis of the current air density D and a current retarding power P_{c} dispensed from the retarding grid 206 to the traction motor/s 212a, 212b. In an embodiment, the system 216 may include a sensor 228 for measuring the current retarding power P_{c} dispensed from the retarding grid 206 to the traction motor/s 212a, 212b. This sensor could be located at either one of the output side of the retarding grid 206 (as shown in the illustrated embodiment of FIG. 2) or at an input side of the traction motor/s 212a, 212b.

Furthermore, the controller 222 may be provided with suitable hardware and/or software to perform an estimation of the current temperature T_{current} at the retarding grid 206. For example, the controller 222 can be programmed to include various pre-defined routines, algorithms, protocols, formulae, or mathematical models to perform the estimation of the current temperature T_{current} of the retarding grid 206. However, it is to be noted that in various other embodiments of the present disclosure, the controller 222 can also be configured to compute the current temperature T_{current} of the retarding grid 206 from theoretical models, statistical models, simulation models, or experimental test data pertaining to previous trial runs of the electric drive system 104 or the retarding grids 206 alone.

The maximum allowable operating temperature Tₘₐₓ, disclosed herein, is generally constant or fixed for a given configuration/size/type of retarding grid 206. However, it may be noted that the maximum allowable operating temperature Tₘₐₓ could vary depending on the configuration/size/type of the retarding grid 206 employed by the electric drive system 104. This maximum allowable operating temperature Tₘₐₓ for the retarding grid 206 disclosed herein may be made known to the controller 222 beforehand. For example, if known beforehand, the maximum allowable operating temperature Tₘₐₓ of the retarding grid 206 could beneficially be set as an upper limit in the controller 222 for performing functions consistent with the present disclosure.

It may be noted that in various embodiments of the present disclosure, the warning signal W generated via the interface 224 is triggered so as to notify the operator of the machine 100 of an imminent overheating of the retarding grids 206 in relative comparison with the maximum allowable operating temperature Tₘₐₓ for the retarding grids 206. Based on the warning signal W, the operator of the machine 100 can slow down the machine 100 and avoid overheating of the retarding grids 206 by allowing sufficient time for the retarding grids 206 to cool as the retarding grids 206 continue to supply power to the traction motor/s 212a, 212b.

Various embodiments disclosed herein are to be taken in the illustrative and explanatory sense, and should in no way be construed as limiting of the present disclosure. All joinder references (e.g., attached, affixed, coupled, engaged, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

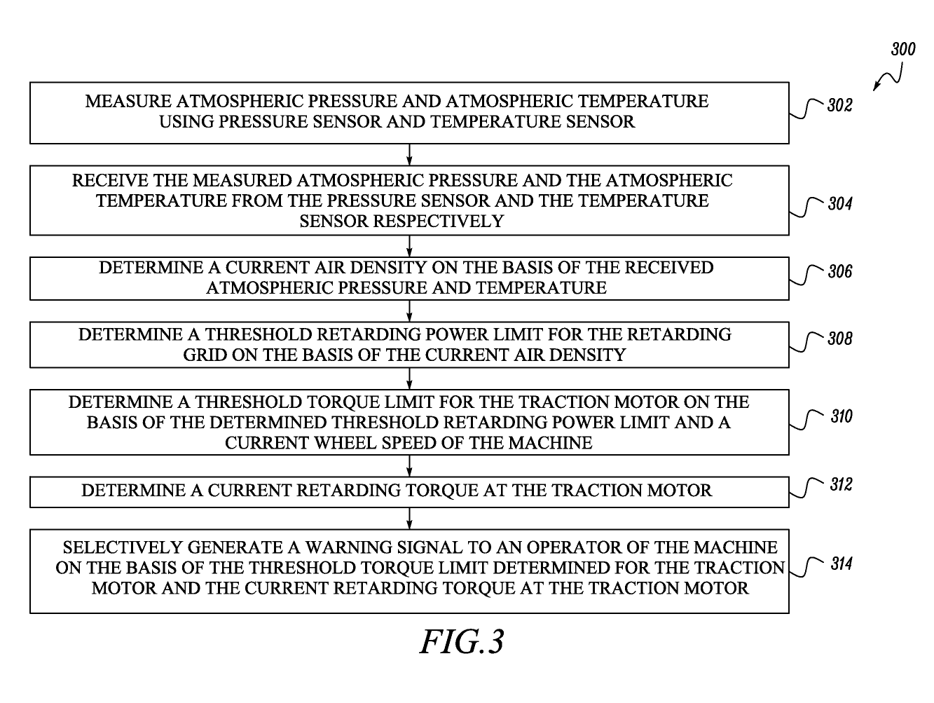

FIG. 3 illustrates a process 300 for monitoring operation of the retarding grid 206. At block 302, the process 300 includes measuring atmospheric pressure P and atmospheric temperature T in real-time. Referring again to FIG. 3, at block 304, the process 300 further includes receiving, by the controller 222, the measured real-time atmospheric pressure P and temperature T from the pressure sensor 218 and the temperature sensor 220 respectively. Thereafter, at block 306, the process 300 further includes determining the current air density D on the basis of the received real-time atmospheric pressure P and temperature T. At block 308, the process 300 further includes determining the threshold retarding power limit Pₗᵢₘᵢₜ for the retarding grid 206 on the basis of the current air density D. At block 310, the process 300 further includes determining the threshold torque limit Tₒ₋ₗᵢₘᵢₜ for the traction motor/s 212a, 212b on the basis of the determined threshold retarding power limit Pₗᵢₘᵢₜ and the current wheel speed S of the machine 100. At block 312, the process 300 further includes determining a current retarding torque T_{o-current} at the traction motor/s 212a, 212b; and at block 314, the process 300 further includes selectively generating the warning signal W to the operator of the machine 100 on the basis of the threshold torque limit Tₒ₋ₗᵢₘᵢₜ determined for the traction motor/s 212a, 212b and the current retarding torque T_{o-current} at the traction motor/s 212a, 212b.

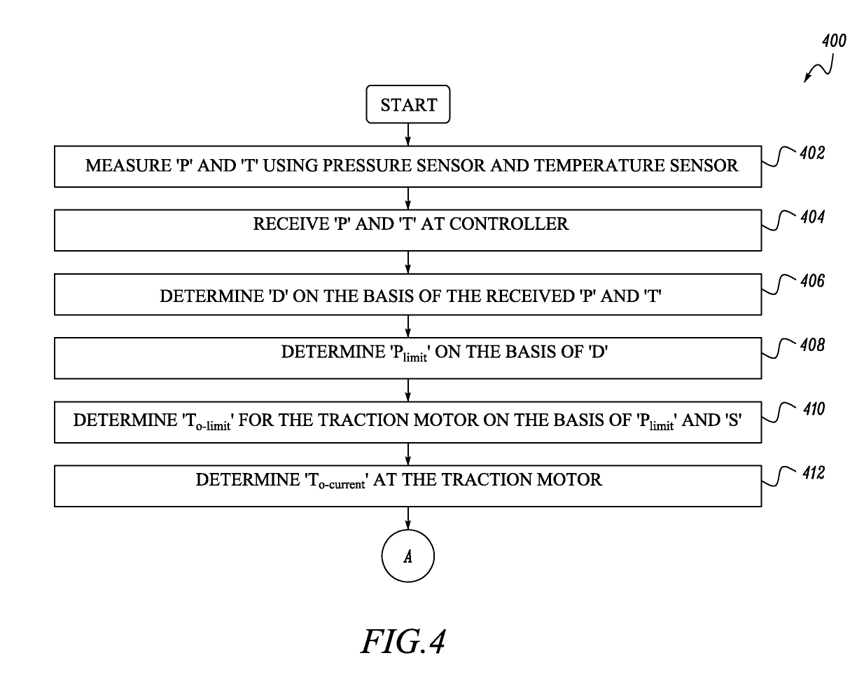

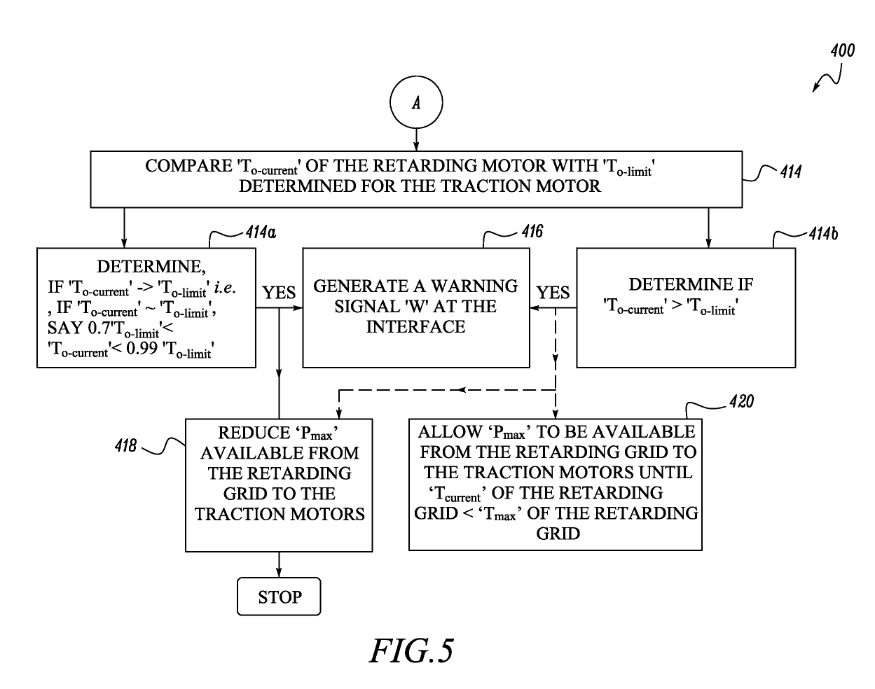

FIG. 4 illustrates a low level implementation 400 of the process 300 (hereinafter simply referred to as ‘process’ and designated with identical numeral ‘400’) for monitoring operation of the retarding grid 206. For the sake of simplicity in drawings and aiding a reader in understanding of the process 400, the process 400 has been illustrated in two parts, namely—FIG. 4 and FIG. 5. However, it may be noted that FIG. 5 is merely a continuation of the process 400 from FIG. 4. As such, a connector ‘A’ has been appended to the bottom of the process 400 in FIG. 4 and at the top of process 400 in FIG. 5 to denote that the process 400 continues from block 412 of FIG. 4 to block 414 of FIG. 5. Therefore, in rendering an explanation of process 400 herein, reference may be made, as required, to one or both of the accompanying drawings i.e., FIG. 4 and FIG. 5.

Referring to FIG. 4, the process 400 is shown to initiate with a ‘start’ block. At block 402, the pressure sensor 218 and the temperature sensor 220 of the system 216 measure the atmospheric pressure P and atmospheric temperature T in real-time. Moreover, at block 404, the controller 222 receives the measured real-time atmospheric pressure P and temperature T from the pressure sensor 218 and the temperature sensor 220 respectively. Thereafter, at block 406, the controller 222 determines the current air density D on the basis of the received real-time atmospheric pressure P and temperature T.

At block 408, the controller 222 determines the threshold retarding power limit Pₗᵢₘᵢₜ for the retarding grid 206 on the basis of the current air density D. At block 410, the controller 222 determines the threshold torque limit Tₒ₋ₗᵢₘᵢₜ for the traction motor/s 212a, 212b on the basis of the determined threshold retarding power limit Pₗᵢₘᵢₜ and the current wheel speed S of the machine 100. At block 412, the controller 222 determines the current retarding torque T_{o-current} at the traction motor/s 212a, 212b.

Thereafter, as shown at block 414 of FIG. 5, the controller 222 compares the current retarding torque T_{o-current} at the traction motor/s 212a, 212b with the threshold torque limit Tₒ₋ₗᵢₘᵢₜ determined for the traction motor/s 212a, 212b. In an embodiment as shown at block 414a of FIG. 5, the controller 222 determines if the current retarding torque T_{o-current} at the traction motor/s 212a, 212b is approaching the threshold torque limit Tₒ₋ₗᵢₘᵢₜ determined for the traction motor/s 212a, 212b, i.e., the controller 222 can determine whether the current retarding torque T_{o-current} at the traction motor/s 212a, 212b is for e.g., at least between 0.7 to 0.99 times that of the threshold torque limit Tₒ₋ₗᵢₘᵢₜ determined for the traction motor/s 212a, 212b. If the current retarding torque T_{o-current} at the traction motor/s 212a, 212b has approached the threshold torque limit Tₒ₋ₗᵢₘᵢₜ determined for the traction motor/s 212a, 212b, then the controller 222 generates the warning signal W at the interface 224 (as shown at block 416 of FIG. 5).

In another embodiment as shown at block 414b of FIG. 5, the controller 222 can be configured to alternatively determine if the current retarding torque T_{o-current} at the traction motor/s 212a, 212b has exceeded the threshold torque limit Tₒ₋ₗᵢₘᵢₜ determined for the traction motor/s 212a, 212b, i.e., the controller 222 can determine if the current retarding torque T_{o-current} at the traction motor/s 212a, 212b is for e.g., at least 1.01 times the threshold torque limit Tₒ₋ₗᵢₘᵢₜ determined for the traction motor/s 212a, 212b. If the current retarding torque T_{o-current} at the traction motor/s 212a, 212b has exceeded the threshold torque limit Tₒ₋ₗᵢₘᵢₜ determined for the traction motor/s 212a, 212b, then the controller 222 generates the warning signal W at the interface 224 (as shown at block 416 of FIG. 5).

Moreover, in an embodiment as shown at block 418 of FIG. 5, if the current retarding torque T_{o-current} at the traction motor/s 212a, 212b has exceeded the threshold torque limit Tₒ₋ₗᵢₘᵢₜ determined for the traction motor/s 212a, 212b, then the controller 222 may, additionally or optionally, reduce the maximum retarding power Pₘₐₓ available from the retarding grid 206 to the traction motor/s 212a, 212b.

However, in an alternative embodiment as shown at block 420 of FIG. 5, if the current retarding torque T_{o-current} at the traction motor/s 212a, 212b has exceeded the threshold torque limit Tₒ₋ₗᵢₘᵢₜ determined for the traction motor/s 212a, 212b, then the controller 222 can continue to optionally allow the maximum retarding power Pₘₐₓ to be available from the retarding grid 206 to the traction motor/s 212a, 212b until a current operating temperature T_{current} of the retarding grid 206 remains lesser than the maximum allowable operating temperature Tₘₐₓ of the retarding grid 206. For instance, as disclosed earlier herein, the controller 222 can determine the period of time t in which the current operating temperature T_{current} of the retarding grid 206 may reach the maximum allowable operating temperature Tₘₐₓ of the retarding grid 206, and allow the maximum retarding power Pₘₐₓ from the retarding grid 206 to be available to the traction motor/s 212a, 212b for the pre-determined period of time t. For example, depending on the current operating conditions of the retarding grid 206, the controller 222 can determine that the current operating temperature T_{current} will reach the maximum allowable operating temperature Tₘₐₓ for the grid in 10 seconds, and can allow the maximum retarding power Pₘₐₓ from the retarding grid 206 to be available to the traction motor/s 212a, 212b for 10 seconds before reducing the maximum retarding power Pₘₐₓ available from the retarding grid 206 to the traction motor/s 212a, 212b. For example, upon completion of 10 seconds, which the current operating temperature T_{current} of the retarding grid 206 may take to reach the maximum allowable operating temperature Tₘₐₓ, the controller 222 may reduce the maximum retarding power Pₘₐₓ available from the retarding grid 206 from say, 4.5 MW to say, 4 MW.

Embodiments of the present disclosure have applicability for use and implementation in monitoring an operation of the retarding grids 206 present on a machine 100. When implemented in a machine 100, the system 216 of the present disclosure can help protect the retarding grids 206 from overheating during operation. As disclosed earlier herein, in one embodiment, the system 216 can generate a warning signal W if the current retarding torque T_{o-current} at the traction motor/s 212a, 212b approaches, i.e., is substantially close to, the threshold torque limit Tₒ₋ₗᵢₘᵢₜ determined for the traction motor/s 212a, 212b. In another embodiment, the system 216 can be optionally configured to generate the warning signal W if the current retarding torque T_{o-current} at the traction motor/s 212a, 212b exceeds the threshold torque limit Tₒ₋ₗᵢₘᵢₜ determined for the traction motor/s 212a, 212b. Additionally, the system 216 can reduce the maximum retarding power Pₘₐₓ available from the retarding grid 206 when the current retarding torque T_{o-current} at the traction motor/s 212a, 212b exceeds the threshold torque limit Tₒ₋ₗᵢₘᵢₜ determined for the traction motor/s 212a, 212b.

In yet an other embodiment, the system 216 can be configured to allow the allow the maximum retarding power Pₘₐₓ from the retarding grid 206 to be available to the traction motor/s 212a, 212b for the pre-determined period of time t in which the current operating temperature T_{current} may reach the maximum allowable operating temperature Tₘₐₓ pre-defined for the retarding grid 206. Thereafter, the system 216 can beneficially reduce the maximum retarding power Pₘₐₓ available from the retarding grid 206 to the traction motor/s 212a, 212b.

By way of embodiments disclosed herein, the controller 222 can be configured to reduce the maximum retarding power Pₘₐₓ available from the retarding grid 206 at various points of operating conditions of the retarding grid 206. By reducing the maximum retarding power Pₘₐₓ available from the retarding grid 206, the controller 222 can beneficially prevent the retarding grids 206 from overheating during operation. Moreover, as the controller 222 triggers warning signals W at the interface 224, the controller 222 can assist operators in knowing when to slow down the machine 100 i.e., lower a wheel speed S of the machine 100 and/or reduce power demands from the machine 100 during operation. This way, the operators can prolong an operating time of the retarding grids 206 with the maximum retarding power Pₘₐₓ from the retarding grids 206 before such maximum retarding power Pₘₐₓ is reduced.

With implementation of embodiments disclosed herein, manufacturers can prolong an operational or service life of the retarding grids 206 thereby mitigating costs, time, and effort previously incurred with repair and/or replacement of retarding grids 206 that have overheated and hence, operated beyond their maximum allowable operating temperature Tₘₐₓ.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A system for monitoring operation of a retarding grid associated with a traction motor of a machine, the system comprising:
a pressure sensor configured to measure atmospheric pressure;
a temperature sensor configured to measure atmospheric temperature; and
a controller communicably coupled to each of the traction motor, the pressure sensor, and the temperature sensor, the controller configured to:
receive the atmospheric pressure and the atmospheric temperature from the pressure sensor and the temperature sensor respectively;
determine a current air density on the basis of the received atmospheric pressure and temperature;
determine a threshold retarding power limit for the retarding grid on the basis of the current air density;
determine a threshold torque limit for the traction motor on the basis of the determined threshold retarding power limit and a current wheel speed of the machine;
determine a current retarding torque at the traction motor; and
selectively generate a warning signal to an operator of the machine on the basis of the threshold torque limit determined for the traction motor and the current retarding torque at the traction motor.

2. The system of claim 1, wherein the controller is configured to generate the warning signal if the current retarding torque at the traction motor approaches the threshold torque limit determined for the traction motor.

3. The system of claim 2, wherein the controller is configured to generate the warning signal when the current retarding torque at the traction motor is in a range of approximately 0.7 to 0.99 times that of the threshold torque limit determined for the traction motor.

4. The system of claim 1, wherein the controller is configured to generate the warning signal if the current retarding torque at the traction motor exceeds the threshold torque limit determined for the traction motor.

5. The system of claim 1, wherein the controller is configured to reduce a maximum retarding power available from the retarding grid to the traction motor if the current retarding torque at the traction motor exceeds the threshold torque limit determined for the traction motor.

6. The system of claim 5, wherein the controller is configured to allow the maximum retarding power from the retarding grid to be available to the traction motor for a pre-determined period of time after the current retarding torque at the traction motor exceeds the threshold torque limit determined for the traction motor.

7. The system of claim 6, wherein the pre-determined period of time corresponds to time taken by a current temperature of the retarding grid to exceed a maximum allowable operating temperature pre-defined for the retarding grid.

8. The system of claim 7, wherein the controller is configured to estimate the current temperature of the retarding grid on the basis of the current air density and a current retarding power dispensed from the retarding grid.

9. A method for monitoring operation of a retarding grid associated with a traction motor of a machine, the method comprising:
measuring, by a pressure sensor, atmospheric pressure;
measuring, by a temperature sensor, atmospheric temperature; and
performing, by a controller, the following steps comprising of:
receiving the atmospheric pressure and the atmospheric temperature from the pressure sensor and the temperature sensor respectively;
determining a current air density on the basis of the received atmospheric pressure and temperature;
determining a threshold retarding power limit for the retarding grid on the basis of the current air density;
determining a threshold torque limit for the traction motor on the basis of the determined threshold retarding power limit and a current wheel speed of the machine;
determining a current retarding torque at the traction motor; and
selectively generating a warning signal to an operator of the machine on the basis of the threshold torque limit determined for the traction motor and the current retarding torque at the traction motor.

10. The method of claim 9, wherein selectively generating the warning signal includes generating the warning signal if the current retarding torque at the traction motor approaches the threshold torque limit determined for the traction motor.

11. The method of claim 9, wherein selectively generating the warning signal includes generating the warning signal if the current retarding torque at the traction motor exceeds the threshold torque limit determined for the traction motor.

12. The method of claim 9 further comprising reducing, by the controller, a maximum retarding power available from the retarding grid to the traction motor if the current retarding torque at the traction motor exceeds the threshold torque limit determined for the traction motor.

13. The method of claim 12 further comprising allowing the maximum retarding power from the retarding grid, by the controller, to be available to the traction motor for a pre-determined period of time after the current retarding torque at the traction motor exceeds the threshold torque limit determined for the traction motor.

14. The method of claim 13, wherein the pre-determined period of time corresponds to time taken by a current temperature of the retarding grid to exceed a maximum allowable operating temperature pre-defined for the retarding grid.

15. The method of claim 14 further comprising measuring, by a temperature sensor, the current temperature of the retarding grid.

16. The method of claim 14 further comprising estimating the current temperature of the retarding grid, by the controller, on the basis of the current air density and a current retarding power dispensed from the retarding grid.

17. A machine comprising:
a traction motor;
at least one retarding grid communicably coupled to the traction motor, the retarding grid configured to operatively provide electric power to the traction motor; and
a system for monitoring operation of the at least one retarding grid, the system comprising:
a pressure sensor configured to measure atmospheric pressure;
a temperature sensor configured to measure atmospheric temperature; and
a controller communicably coupled to each of the traction motor, the pressure sensor, and the temperature sensor, the controller configured to:
receive the atmospheric pressure and the atmospheric temperature from the pressure sensor and the temperature sensor respectively;
determine a current air density on the basis of the received atmospheric pressure and temperature;
determine a threshold retarding power limit for the retarding grid on the basis of the current air density;
determine a threshold torque limit for the traction motor on the basis of the determined threshold retarding power limit and a current wheel speed of the machine;
determine a current retarding torque at the traction motor; and
selectively generate a warning signal to an operator of the machine on the basis of the threshold torque limit determined for the traction motor and the current retarding torque at the traction motor, wherein the controller is configured to generate the warning signal if the current retarding torque at the traction motor approaches the threshold torque limit determined for the traction motor.

18. The machine of claim 17, wherein the controller is configured to generate the warning signal when the current retarding torque at the traction motor is in a range of approximately 0.7 to 0.99 times that of the threshold torque limit determined for the traction motor.

19. The machine of claim 17, wherein the controller is configured to reduce a maximum retarding power available from the retarding grid to the traction motor if the current retarding torque at the traction motor exceeds the threshold torque limit determined for the traction motor.

20. The machine of claim 19, wherein the controller is further configured to:
estimate a current temperature of the retarding grid on the basis of the current air density and a current retarding power dispensed from the retarding grid;
determine a period of time for the current temperature of the retarding grid to exceed a maximum allowable operating temperature pre-defined for the retarding grid; and
allow the maximum retarding power from the retarding grid to be available to the traction motor for the pre-determined period of time.
